(19) United States
(12) Patent Application Publication
(10) Pub. No.: US 2008/0253645 A1
(43) Pub. Date: Oct. 16, 2008

(54) Adaptive Classifier, and Method of Creation of Classification Parameters Therefor

(75) Inventors: Detlef D Nauck, Ipswich (GB); Frank Klawonn, Braunschweig (DE)

Correspondence Address: NIXON & VANDERHYE, PC, 901 NORTH GLEBE ROAD, 11TH FLOOR, ARLINGTON, VA, 22203, US

(73) Assignee: British Telecommunications Public Limited Company, London (GB)

(21) Appl. No.: 11/887,401

(22) PCT Filed: Mar. 21, 2006
(86) PCT No.: PCT/GB2006/001022

§ 371 Date: Sep. 28, 2007

(30) Foreign Application Priority Data
Apr. 1, 2005 (EP) 05252068.1

(51) Int. Cl. G06K 9/62

(52) U.S. Cl. 382/159

(57) ABSTRACT

A method of generating classifier parameters from a plurality of multivariate sample data, for use in subsequent classification, said classifier parameters relating to a plurality of intervals on each of the variables, said intervals being associated with classes, comprising: inputting said sample data; calculating a plurality of boundaries for each of said variables from said sample data, and deriving parameters defining said intervals from said boundaries.

### FIELD OF THE INVENTION

This invention relates to apparatus and methods for generating classifier parameters from multivariate sample data.

### BACKGROUND TO THE INVENTION

Pattern recognizers (classifiers) are known. These are used for a variety of mechanical recognition tasks. Amongst the most challenging is fraud detection. For example, automatic detectors for banknotes must classify the note as genuine or fraudulent. Likewise, automatic transaction systems such as Automated Teller Machine (ATM) systems or credit card networks must be able to detect potentially fraudulent transactions, given the increasing incidence of physical theft or “identity theft”. Fraud detection systems must be sensibly tuned such that the ratios of false positives to true positives (positive=fraud) and false negatives to true negatives are both small. Too many false positives alienates users and reduces revenue due to wrongly barred users, whereas too many false negatives results in direct loss of income due to successful fraud. Such highly accurate, real-time recognition tasks are completely beyond the capacity of human beings, and require reliable, high-speed machine recognition. Fraud detection systems typically use a classification model that receives transaction details as input and produces a fraud indicator as output.

It is necessary to update many recognition systems to deal with progressive changes in data. This is particularly true of a fraud detection system, because fraud patterns are highly dynamic as fraudsters adjust their behaviour to the success of fraud detection solutions.

In order to support the design, tuning and maintenance of fraud detection solutions suitable classification models need to be used. Fuzzy rule-based systems are suitable for such purposes, because such systems can be easily interpreted by a human observer (so as to allow easy correction where a rule is wrongly being used), they tolerate small changes in the data, it is easy to adjust them and they can be learned from data by so-called neuro-fuzzy techniques. The notion of fuzzy sets was introduced by L. A. Zadeh (L. A. Zadeh, Fuzzy Sets. Information and Control 8 (1965), 338-353)

The initial design, and each subsequent updating, of a fuzzy system requires the definition and choice of a variety of parameters. When constructing a fuzzy system from data, it is necessary to determine:
the number of fuzzy sets for each attribute;
the shape of the fuzzy sets;
the number of rules we want to use; and
the structure of each rule.

Learning fuzzy classification rules from data can be done at present, for example, with neuro-fuzzy systems as performed by NEFCLASS, described by Nauck et al. (D. Nauck, F. Klawonn, R. Kruse: “Foundations of Neuro-Fuzzy Systems”, Wiley, Chichester, 1997). The system would receive transaction data as input. Each transaction would be labelled as either genuine or fraudulent.

In order to derive a classifier for fraud detection, such a neuro-fuzzy system requires the specification of the number of fuzzy sets for each attribute and initial fuzzy sets. This is a critical design factor and in the prior art, the user is responsible for this task. After this step, based on these fuzzy sets, a rule base can be learned and the fuzzy sets are then optimised. Finally, pruning of rules and fuzzy sets is carried out.

Although certain redundancies can be eliminated in the pruning step, a bad choice of the initial fuzzy sets can slow down the learning process significantly or even let the training algorithm get stuck in a local minimum. Thus, such a strategy either requires human intervention and detailed knowledge of the underlying data (which is obviously too slow for rapid updating of a real-time classifier) or, without such intervention and knowledge, a lengthy trial and error strategy in finding the appropriate (number of) fuzzy sets (which is also too slow to be used to update a real-time classifier).

### SUMMARY OF THE INVENTION

Embodiments of the invention are intended to provide a faster method of determining suitable initial fuzzy sets for fuzzy classifiers that are created from data by a learning process, thus enabling it to be used to rapidly update a classifier used in a time-critical application such as fraud detection. This may be achieved by apparatus according to claim 1 or a method according to claim 14.

Embodiments of the invention operate by automatically creating initial fuzzy partitions from partitions between intervals along each attribute. Embodiments of the invention aim to compute partitions for large numbers of attributes and/or sets. Embodiments provide methods to reduce the number of partitions (and hence sets) by considering combinations of attributes. An embodiment reduces numbers of partitions for high-dimensional problems by pair-wise considering pairs of attributes at a time.

Embodiments use entropy-based strategies for finding the initial number and initial distribution of fuzzy sets for classification problems.

A preferred embodiment first considers all attributes independently and creates fuzzy partitions for each attribute. In a second step, dependencies between attributes are exploited in order to reduce the partitions (number of fuzzy sets) for as many attributes as possible.

Other preferred features and embodiments are described and claimed below, with advantages which will be apparent from the following description.

At this point, it may be mentioned that some prior work in relation to non-fuzzy classifiers can, with hindsight, be seen to have similarities to embodiments of the invention. For example, Fayyad & Irani (U. M. Fayyad, K. B. Irani: “On the Handling of Continuous-Valued Attributes in Decision Tree Generation”, Machine Learning, 8 (1992), 87-102) describe computation of boundary points for non-fuzzy intervals, and Elomaa & Rousu (T. Elomaa, J. Rousu: “Finding Optimal Multi-Splits for Numerical Attributes in Decision Tree Learning”, Technical Report NC-TR-96-041, Department of Computer Science, Royal Holloway University of London (1996)) provide algorithms for computing optimal non-fuzzy interval partitions in the special case where the problem is characterized by a small low-dimensional data set. However, neither of these works remotely suggests how to provide parameters of a fuzzy classifier.

Another paper by Elomaa & Rousu entitled “General and Efficient Multisplitting of Numerical Attributes” (Machine Learning, 36 (1999), 201-244) looks at different attribute evaluation functions and their performance in the context of finding optimal multi-splits (i.e. partitioning of attribute domains) based on the boundary point method. The paper does not introduce any new partitioning or splitting techniques beyond those in the prior art discussed above, however. This paper is only concerned with proving that certain evaluation measures define optimal splits on boundary points. That means that it is not necessary to look at all possible cut points but just at boundary points which are a subset of the cut points. Embodiments of the present invention are not based on such a “boundary point” method.

A further paper by Elomaa & Rousu entitled “Efficient Multisplitting Revisited: Optima Preserving Elimination of Partition Candidates” (Data Mining and Knowledge Discovery, 8 (2004), 97-126) extends the proofs from the above paper to segment borders which are a subset of boundary points, i.e. they show that it is not necessary to look at all boundary points to find optimal splits. However, this is fundamentally still a boundary point method and as noted above, embodiments of the present invention are not based on such a method. This paper then goes on to show how this improved boundary point (segment border) method can be made faster by discarding partition candidates (i.e. combinations of segment borders) during the search for the optimal partitions (splits), but it will be understood that this still does not constitute a partitioning method of the type to which the present invention relates.

Referring briefly to two further papers, Zeidler et al: “Fuzzy Decision Trees and Numerical Attributes” (Proceedings of the Fifth IEEE International Conference on Fuzzy Systems, 1996, Volume 2, 985-990) describes an application of the boundary point algorithm to generate fuzzy sets for numerical variables used in a (fuzzy) decision tree, and Peng & Flach: “Soft Discretization to Enhance the Continuous Decision Tree Induction” (Integrating Aspects of Data Mining, Decision Support and Meta-Learning, ECML/PKDD workshop notes, Sep. 2001, 1-11) also simply applies the boundary point algorithm to partition a variable and to generate fuzzy sets, but is restricted to binary splits only.

Referring to prior patent documents of background relevance, EP 0 681 249 (IBM) refers to a fuzzy system for fraud detection, and EP 1 081 622 (NCR International) refers to an expert system for decision support.

### BRIEF DESCRIPTION OF THE DRAWINGS

Embodiments of the invention will now be described, by way of example only, with reference to the accompanying drawings in which:

FIG. 1 is a block diagram showing the structure of an adaptive classifier according to a preferred embodiment of the invention;

FIG. 2a is a block diagram showing the structure of a fuzzy classifier known per se, and forming part of the adaptive classifier of FIG. 1; and

FIG. 2b is a block diagram showing the structure of a training device for deriving updated parameters for the classifier of FIG. 2a, and forming part of the adaptive classifier of FIG. 1;

FIG. 3 is a flow diagram showing the overall operation of the adaptive classifier of FIG. 1 for fraud detection;

FIG. 4 is a flow diagram forming part of FIG. 3, showing the operation of the fuzzy classifier of FIG. 2;

FIG. 5 is an illustrative plot of fuzzy membership function against attribute value, showing partitions between sets (known per se), to illustrate the operation of the classifier of FIG. 2;

FIG. 6 is a flow diagram showing the main algorithm for partitioning attributes to derive fuzzy sets in the preferred embodiment;

FIG. 7 is a flow diagram forming part of FIG. 6, showing an algorithm to partition a single attribute in the preferred embodiment;

FIG. 8 is a flow diagram forming part of FIG. 7, showing an algorithm to compute an attribute partition in the preferred embodiment;

FIG. 9 is a flow diagram forming part of FIG. 8, showing the heuristics for computing a partition if there are too many boundary points in the preferred embodiment;

FIG. 10 is a flow diagram forming part of FIG. 6, showing the algorithm for multidimensional partition simplification in the preferred embodiment;

FIG. 11 is a flow diagram forming part of FIG. 6, showing the algorithm for pair-by-pair partition simplification in the preferred embodiment;

FIG. 12 corresponds to FIG. 5 and illustrates the formation of fuzzy partitions from interval partitions in the sample data; and

FIG. 13 is a plot in three dimensional space defined by three attributes as axes, showing a box induced by a datum in which one attribute value is missing.

### DESCRIPTION OF PREFERRED EMBODIMENTS

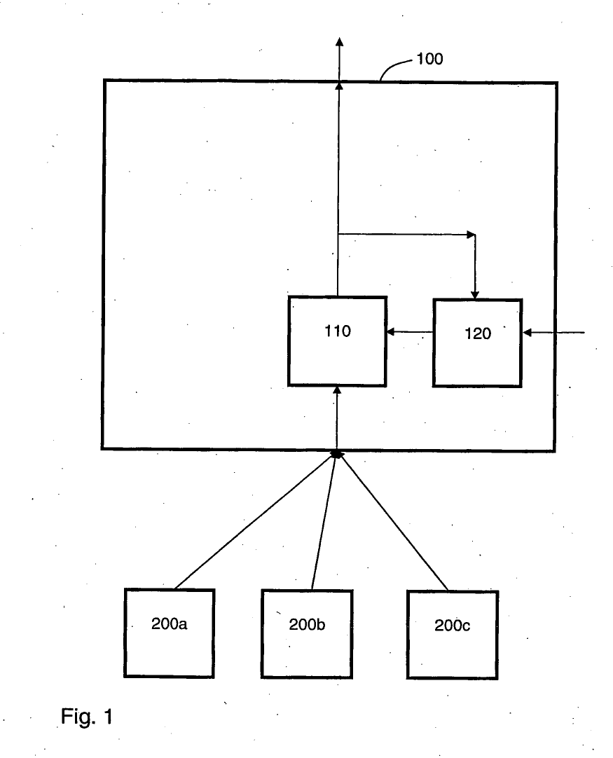

Referring to FIG. 1, an adaptive classification system according to a preferred embodiment of the invention, 100, comprises a classifier 110 and a training device 120. This classification system 100 is implemented on a computing system such as an embedded microcontroller, and accordingly comprises memory 150 (e.g. RAM), a long term storage device 160 (e.g. EPROM or FLASH memory, or alternatively a disk drive), a central processing unit 170 (e.g. a microcomputer) and suitable communications buses 180. For clarity, these conventional components are omitted from the drawings.

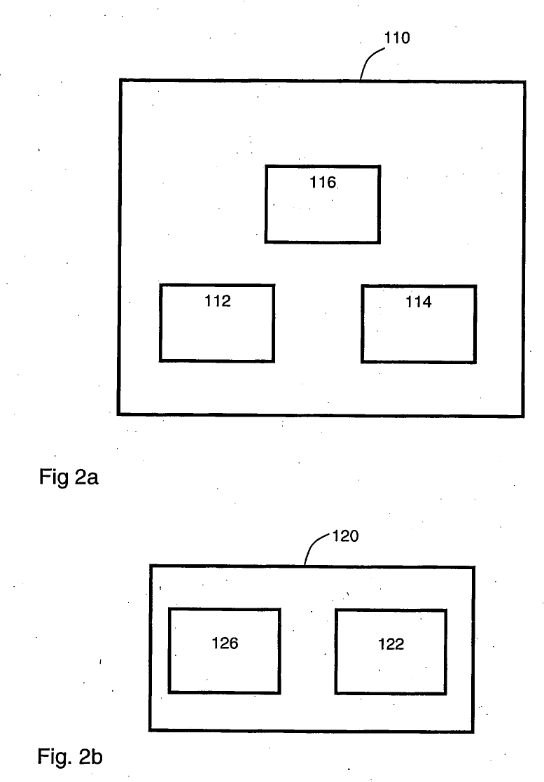

Referring to FIG. 2a, the classifier in the preferred embodiment is a known fuzzy rule-based classifier, the theory of which is described in Zadeh and numerable subsequent papers. The classifier 110 comprises a fuzzy set store 112 (e.g. a file within the storage device 160), a rule store 114 (e.g. a file within the storage device 160) and a calculation device 116 (implemented in practice by the CPU 170 operating under a control program stored in the storage device 160).

Connected to the classifier 110 are the outputs of a plurality of sensors 200a, 200b, 200c each of which generates an output in response to a corresponding input. Collectively, the outputs of all the sensors 200 in response to an external event such as a transaction comprise a vector of attribute values which is the input to the classifier 110.

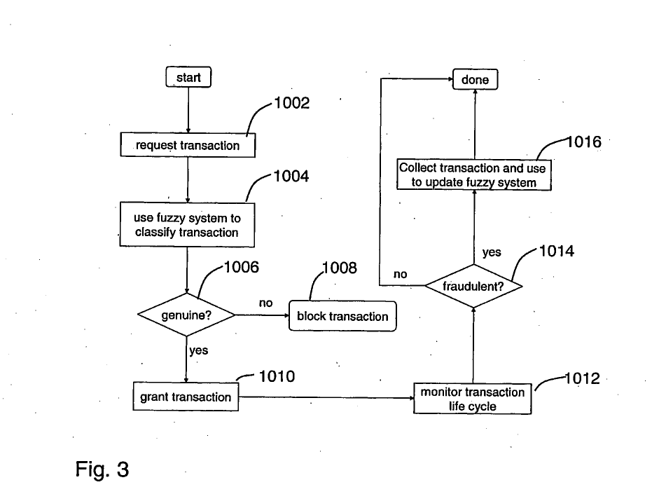

Referring to FIG. 2b, the training device 120 comprises a training data store 122 (e.g. a file within the storage device 160) and a calculation device 126 (implemented in practice by the CPU 170 operating under a control program stored in the storage device 160). Referring to FIG. 3, the operation of the system of FIGS. 1 and 2 in fraud detection is as follows. In step 1002, a transaction is requested by a user, and accordingly a set of attribute values are collected by the sensors 200a-200c . . . . For example, the data may comprise a credit card number input through a terminal, a signature collected on a touch sensitive pad, and a plurality of biometric measurements (e.g. fingerprint and/or voice parameter measurements), location data on the location of the user, and product data indicating the nature of the transaction (e.g. type of goods), and the price of the transaction. Alternatively, the sensors may each sense a parameter of an input monetary unit such as a banknote, and the attributes may therefore be a plurality of different size and/or colour measurements of the banknote.

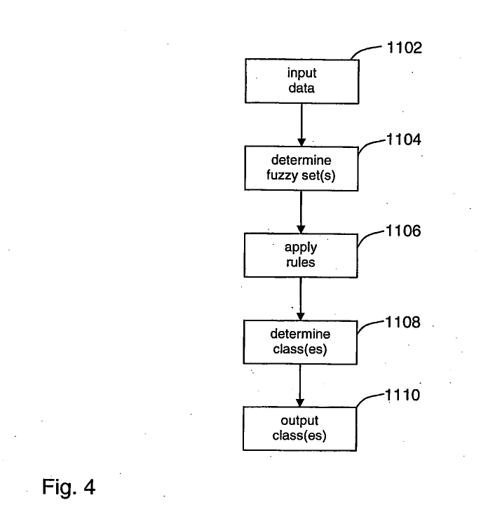

In step 1004, the process of FIG. 4 (described below), is performed to classify the transaction. In step 1006, the outputs for each possible class are processed to determine if the transaction is genuine or not. One or more output classes correspond to a fraudulent transaction, and if such a class has the highest class output from the classifier, the transaction is deemed fraudulent. It may also be deemed fraudulent if, for example, another (non-fraudulent) class has a higher value, but the different between the output for the non fraudulent class and that for the nearest fraudulent class does not exceed a predetermined threshold. If the transaction is determined to be fraudulent then, in step 1008, it is blocked whereas if it is not determined to be fraudulent then, in step 1010, it is granted. The transaction data, and the class outputs, are stored (step 1012). If, subsequently, it is determined that a transaction which was deemed fraudulent was, in fact genuine, (or vice versa) then the data (step 1014) is collected for future use in re-training the classifier (step 1016).

### Overview of Classifier

The operation of the classifier 110 performed in step 1004 will now be described in greater detail.

The test data input (step 1102) from the sensors 200 forms a vector of n attribute values:

$$\{ {x}_{1} , … , {x}_{n} \} ⊆ {\prod }_{j = 1}^{p} ( {I}_{j} ⋃ \{ ? \})$$

Each vector datum xᵢ has p real-valued attributes lying in the intervals I1, . . . , Ip, but there may be missing values in one or more attributes (indicated by the symbol ‘?’). Integer-valued or categorical attributes from the sensors 200 are encoded in a real-valued attribute output.

A class is to be assigned to each datum. There are c classes, numbered {1, . . . , c}. C(xᵢ) denotes the class assigned to xᵢ. The classifier 110 performs a mapping K such that:

$$K \text{:} {\prod }_{j = 1}^{p} ( {I}_{j} ⋃ \{ ? \})→\{1,… ,c\}.$$

A fuzzy classifier used in the preferred embodiment operates using one or more suitable fuzzy sets μ₁^{(j)}, . . . , μₘ_{ⱼ}^{(j)} on each interval Iⱼ, stored in the set store 112, and a set of rules (stored in the rule store 112) of the form “If attribute j₁ is μ₁^{(j)} and . . . and attribute jᵣ is μⱼ_{ᵣ}^{(j)} then class is k”, where kε{1, . . . , c} is the number of the corresponding class and the μᵢ^{(j)} are fuzzy sets defined on the ranges of the corresponding attribute. It is not required that all attributes occur in a rule. It is sufficient that the rule premise refers to a subset of the attributes.

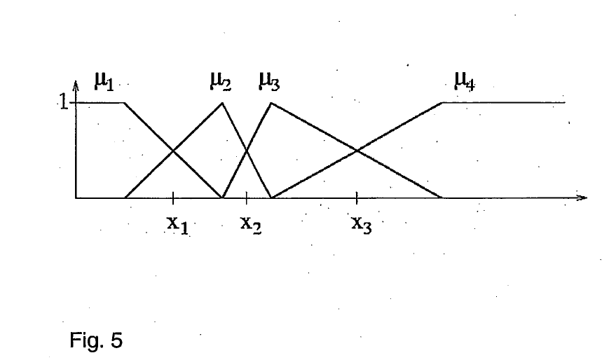

The typical distribution of fuzzy sets along one attribute axis is shown in FIG. 5. Each set has a membership function valued between 0 and +1. Each set has a middle point at which the membership function is +1. The first and last sets have the function at +1 respectively below and above the middle point. All others have membership functions linearly or non-linearly falling away to zero above and below the middle point. The points at which the membership functions of adjacent sets cross define partitions between the sets.

Each set corresponds to a class. Several sets may correspond to a single class (i.e. where the data on the attribute in question is bimodal or multimodal).

The calculation device 116 determines (step 1104) the set into which each input attribute falls, and then applies the rules (step 1106) to determine the class(es) (step 1108) into which the input data vector is classified.

### Evaluating a Single Rule

Given a datum

$$x ∈ {\prod }_{j = 1}^{p} ( {I}_{j} ⋃ \{ ? \})$$

the classifier evaluates a single rule by computing the minimum of the membership degrees of all the attribute values mentioned in the rule (i.e. the weakest correspondence with a fuzzy set). If the datum x has a missing attribute value, the membership degree to the corresponding fuzzy set is set at one (i.e. the maximum possible membership degree), as described in Berthold et al (M. Berthold, K.-P. Huber: “Tolerating Missing Values in a Fuzzy Environment”, M. Mares, R. Mesiar, V. Novak, J. Ramik, A. Stupnanova (eds.): Proc. Seventh International Fuzzy Systems Association World Congress IFSA'97, Vol. I. Academia, Prague (1997), 359-362).

For each class the classifier determines a membership degree of x by the maximum value of all rules that point to the corresponding class. The fuzzy classifier assigns x to the class with the highest membership degree.

The classifier then outputs a result (step 1110), typically in the form of one or more class labels (i.e. text identifying the class such as “genuine” or “fraudulent”).

### Training

The classifier 110 will be “trained” (i.e. provided with sets and rules for storage and subsequent use in classification) using a plurality of training data, comprising the sensor attribute outputs from past transactions together with their (known) classes. Each vector in the training data set has n attributes (although, as discussed above, one or more of the attributes may be missing).

The set and rule parameters are derived by the training device 120 on the basis of one part of the sample (or training) data set and the training is then evaluated with respect to the misclassifications counted on the data not used for learning. The process of deriving the parameters in a preferred embodiment will now be described in greater detail.

Before a fuzzy classifier for a fraud detection system is created by using a neuro-fuzzy learning procedure, it is necessary to specify fuzzy partitions, i.e. the number, shape and position of fuzzy sets, for each attribute of a transaction. In the following embodiment, this is done automatically. Firstly, all attributes are analysed independently, and partitions are created for each, defining numbers and positions of fuzzy sets. Secondly, dependencies between attributes are exploited in order to reduce the number of partitions (and hence number of fuzzy sets) for as many attributes as possible.

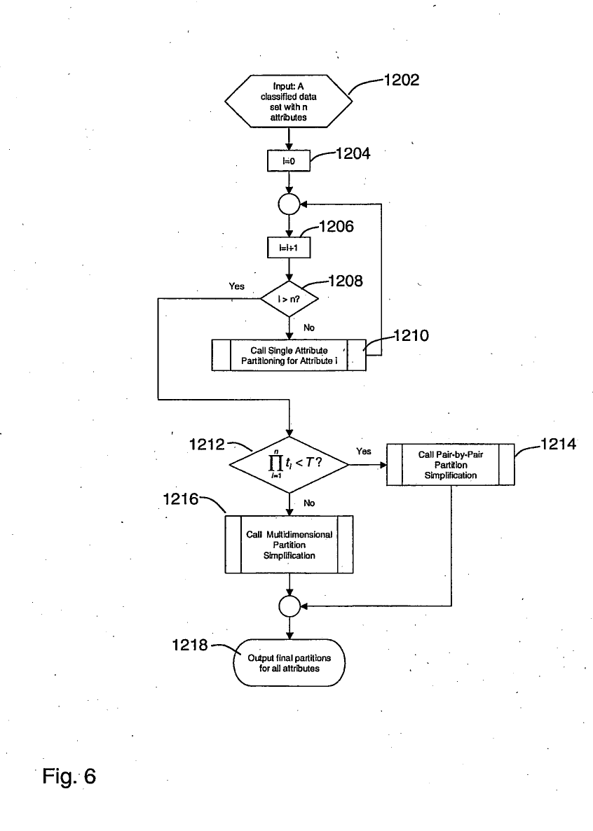

Referring to FIG. 6, in step 1202, the training data set is input and stored in the training data store 122. In step 1204, a counter i is initialised at zero and in step 1206 it is increment.

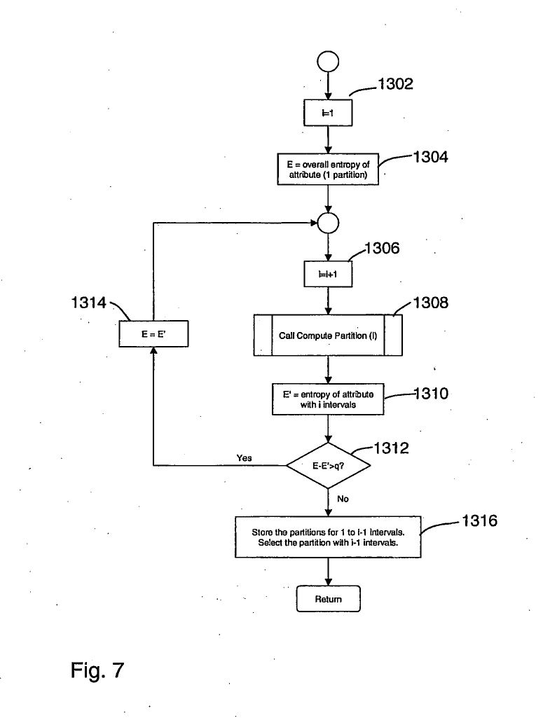

In step 1208, the calculation device 126 determines whether the attribute counter i has gone beyond the last attribute value n and, if not, the process of FIG. 7 is performed to calculate partitions on the selected attribute, and subsequently, the calculation device 126 returns to step 1206 to select the next attribute.

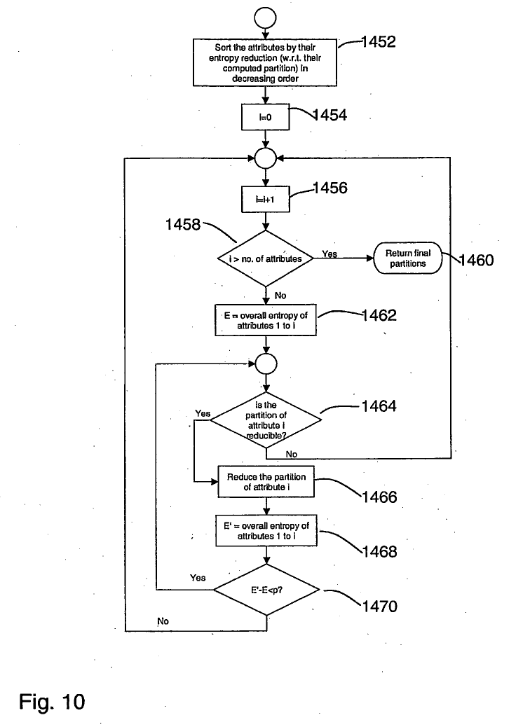

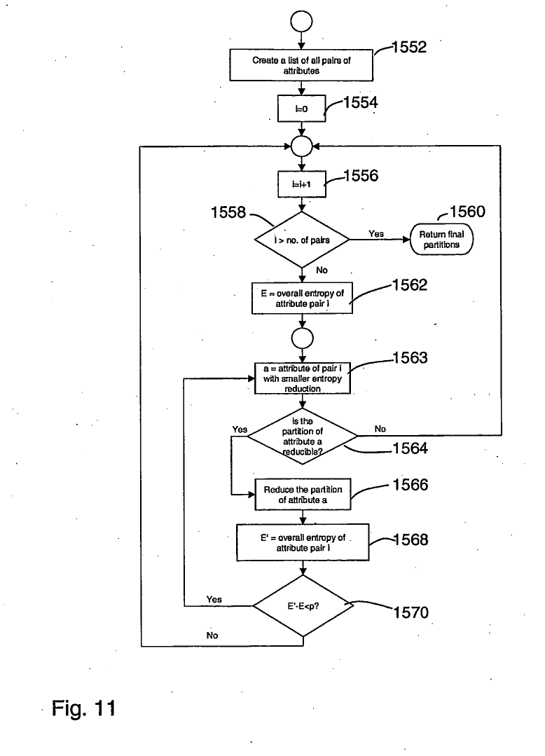

When all attributes have been processed (step 1208), then in step 1212, the calculation device 116 determines whether the number of possible combinations of attribute partitions on all the attributes could computationally be processed within a reasonable time and, if so, in step 1214, the calculation device performs the pair-by-pair partition simplification process of FIG. 11. If it would not be computationally feasible (i.e. the combinations exceeds a predetermined threshold T in step 1212) then calculation device performs the multidimensional partition simplification process of FIG. 10 in step 1216. After performing the process of either FIG. 11 or FIG. 10, in step 1218 the fuzzy set parameter data calculated for attributes is output from the training device 120 to be stored by the classifier 110 for subsequent classification.

### Partitioning a Single Attribute

A fuzzy classifier that uses only a single attribute will partition the range of the attribute into disjoint intervals. This is true at least if the fuzzy sets satisfy typical restrictions, for instance that they are unimodal and that never more than two fuzzy sets overlap.

A typical choice of fuzzy sets is depicted in FIG. 5. In this case, fuzzy set μ₁ prevails for values less than x₁, μ₂ for values between x₁ and x₂, μ₃ for values between x₂ and x₃, and μ₄ for values larger than x₃.

The situation is different, if more than one attribute is considered. A fuzzy partition as shown in FIG. 5 induces a partition into disjoint intervals for one attribute. From these interval partitions, the product space of all attribute ranges is partitioned into hyper-boxes. If all possible rules are used and each rule is referring to all attributes, the resulting classifier will assign a class to each hyper-box, according to Kuncheva (L. I. Kuncheva: “How Good are Fuzzy If-Then Classifiers?”, IEEE Transactions on Systems, Man, and Cybernetics, Part B: 30 (2000), 501-509). If not all rules are used, class boundaries can be found within hyper-boxes.

### Finding a Partition for a Fixed Number of Intervals

In order better to explain the process to be performed, some background explanation will now be given. Having in mind the view of a classifier based approximately on a partition of the input space into hyper-boxes, it is possible to see an analogy to decision trees. Standard decision trees are designed to build a classifier using binary attributes or, more generally, using categorical attributes with a finite number of values. In order to construct a decision tree in the presence of real-valued attributes, a discretisation of the corresponding ranges is required. The decision tree will then perform the classification task by assigning classes to the hyper-boxes (or unions of these hyper-boxes) induced by the discretisation of the attributes.

The task of discretisation for decision trees is guided by the same principle as the construction of the decision tree itself. In each step of the construction of the decision tree the attribute is chosen for a further split that maximises the information gain, which is usually defined as the expected reduction in entropy.

In the field of binary decision trees, Elomaa and Rousu: “Finding Optimal Multi-Splits for Numerical Attributes in Decision Tree Learning” (1996), referred to earlier, proposed a technique for splitting/discretisation of a range into more than two intervals. This was reached by generalising a method for binary splits by Fayyad and Irani in “On the Handling of Continuous-Valued Attributes in Decision Tree Generation” (1992) also referred to earlier.

The problem can be defined as follows (when data with a missing value in the considered attribute are simply ignored). We consider a single attribute j and want to partition the range into a fixed number t of intervals. This means that we have to specify t−1 cut points T₁, . . . , Tₜ₋₁, within the range. The cut points should be chosen in such a way that the entropy of the partition is minimised. Let T₀ and Tₜ denote the left and right boundary of the range, respectively.

Assume that nₗ (i=1, . . . , t) of the n data fall into the interval between Tⱼ₋₁ and Tₗ, when we consider only the j^{th} attribute. Let k_{q} denote the number of the nᵢ data that belong to class q. Then the entropy in this interval is given by:

$${E}_{i} = - {\sum }_{q = 1}^{c} \frac{{k}_{q}}{{n}_{i}} \cdot log ( \frac{{k}_{q}}{{n}_{i}} ) \qquad Equation 1$$

The overall entropy of the partition induced by the cut points is then the weighted sum of the single entropies:

$$E = {\sum }_{i = 1}^{t} \frac{{n}_{i}}{n} \cdot {E}_{i} \qquad Equation 2$$

which should be minimised by the choice of the cut points. Here, n is the number of data where attribute j does not have a missing value.

### Determining the Number of Intervals

Since the present embodiment does not fix the number of intervals in advance, it is necessary to employ a criterion determining how many intervals should be provided. It is obvious that the entropy Equation 2 decreases with the number of intervals t, at least for optimal partitions. Therefore, the present embodiment starts with a binary split of two intervals, and iteratively increases the number of intervals whilst the increase continues to reduce the entropy compared to the previous partition by more than a certain percentage, or until a predetermined maximum number of intervals is exceeded.

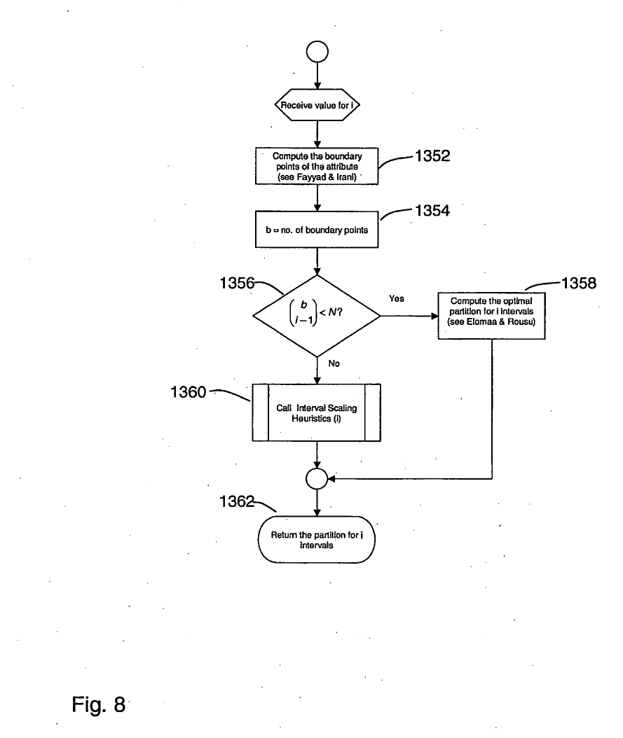

Referring to FIG. 7, in a step 1302, a partition number counter i is initialised at 1. In a step 1304, a variable E, entropy, is initialised at the value of a single partition. In step 1306, the calculation device 1306 increments the counter i. In step 1308, the process of FIG. 8 (to be described in greater detail below) is performed, to compute the partition position for i partitions. In step 1310, the entropy E′ of the attribute with i intervals is calculated. In step 1312, the difference between the previous value for entropy and the current value E′ (i.e. the decrease in entropy created by adding one more partition) is calculated, and tested against an empirically determined threshold q. If the entropy reduction exceeds the threshold, then in step 1314, the current entropy value E is set to E′ and the calculation device 126 returns to step 1306 to repeat the process for one more partition. When, eventually, the addition of a further partition results in no significant decrease in entropy (step 1312), then in step 1316, the partition positions calculated in all previous iterations are stored, for reasons which will be explained later, and the partition number and values with i−1 intervals are saved for subsequent use. The process of FIG. 7 then returns to that of FIG. 6.

### Computing Partitions

If the data is sorted with respect to its values in the j^{th} attribute, it was proved in Elomaa et al in “Finding Optimal Multi-Splits for Numerical Attributes in Decision Tree Learning” (1996), referred to earlier, that for an optimal splitting, only boundary points have to be considered as cut points. The present embodiment therefore calculates the boundary points along each attribute.

A value T in the range of attribute j is formally defined as a boundary point if, in the sequence of data sorted by the value of attribute j, there exist two data x and y, having different classes, such that xⱼ<T<yⱼ, and there is no other datum z such that xⱼ<zⱼ<yⱼ.

In the following example (Table 1) the values of attribute j of data points are shown on the upper line, sorted into ascending order by their attribute values, and the corresponding classes of the data are shown on the lower line. Boundary points are marked by lines.

TABLE 1
Boundary Points

| | |
|---|---|
| value: | 1 2 \| 3 3 4 \| 5 5 \| 6 6 \| 7 8 8 9 \| 10 \| 11 11 12 |
| class: | 3 3 \| 1 1 1 \| 2 2 \| 1 3 \| 3 3 3 3 \| 2 \| 1 1 1 |

Note that different data vectors might have the same attribute values (as shown in the Table). Although this situation seldom occurs when the attribute is really continuous-valued, it is very common for integer-valued attributes. The boundary points T are allocated values intermediate between those of the neighbouring data x and y (e.g. 2.5, 4.5, 5.5, 5.5, 9.5, 10.5 in Table 1).

In step 1352, the boundary points along the attribute are calculated using the method described in Fayyad and Irani in “On the Handling of Continuous-Valued Attributes in Decision Tree Generation” (1992) referred to earlier, and a counter b is set equal to the number of boundary points in step 1354.

From the computed boundary points, the optimal discretisation minimising Equation 2 for a fixed number of intervals can be determined. For b boundary points and t intervals, it is necessary to evaluate

$$( \begin{matrix}b \\ t - 1\end{matrix} )$$

partitions. The worst case would be where the number of boundary points b equals the number of sample data n−1 (i.e. there are boundaries between every datum and its neighbours). But usually b<<n so that even in the case of large data sets

$$( \begin{matrix}b \\ t - 1\end{matrix} )$$

remains a computationally tractable number for small values of t.

In step 1356, accordingly, the calculation device 126 determines whether the total number of different arrangements of (t−1) partitions within b boundary points exceeds a predetermined threshold N and if not, the optimum partition is directly calculated in step 1358 by the method of Elomaa and Rousu referred to above.

As long as the method based on the boundary points seems computationally tractable, depending on the number

$$( \begin{matrix}b \\ t - 1\end{matrix} )$$

mentioned in the previous subsection, we apply the boundary point method. On the other hand, if (step 1360)

$$( \begin{matrix}b \\ t - 1\end{matrix} )$$

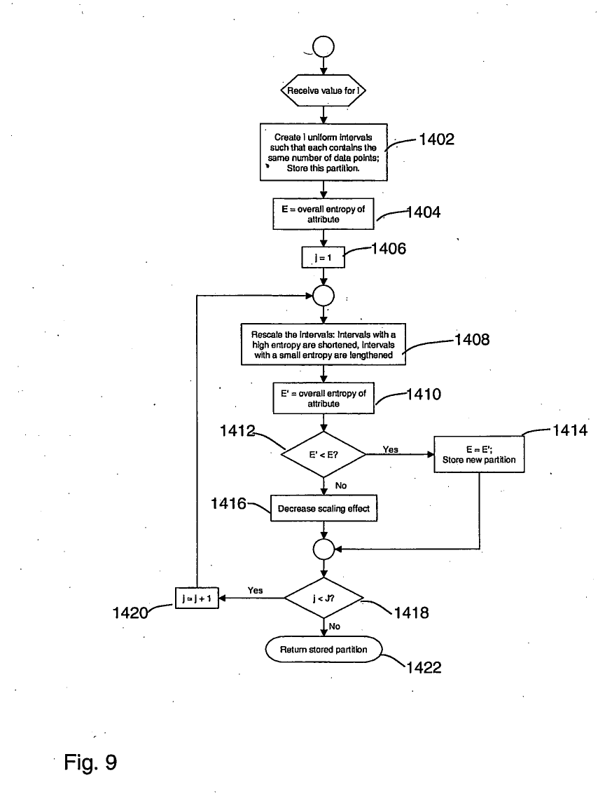

is not acceptable in terms of computation time, a heuristic method described in FIG. 9 is used (step 1360) to find a partition yielding a small value for Equation 2.

Either way, the set of partition positions selected (i.e. the t−1 of the b boundary points chosen to act as partitions) is returned to the process of FIG. 7 (step 1362).

Computing a Partition if there are too Many Boundary Points

Referring to FIG. 9, where (in step 1356) there are too many boundary points to use the above-described method, then the following steps are performed.

Having received the current number of partitions i, in step 1402, a set of initial boundaries is created, such as to divide the attribute range into intervals each containing the same number of data points (or approximately so), and stored. In step 1404, the entropy of the attributes E is calculated for these partitions as disclosed above. In step 1406, a loop counter j is initialised at 1. In step 1408, the intervals are rescaled so as to change their widths; specifically, intervals with relatively high entropy (as calculated above) are shortened whereas those relatively low entropy are lengthened. The scaling may be performed, for example, by multiplying by a predetermined constant to lengthen, and by dividing by the predetermined constant to shorten.

In step 1410, the overall entropy of the attribute with the rescaled partitions, E, is calculated (as in step 1404) and in step 1412, the calculating device 126 calculates whether there has been a decrease in entropy due to the resealing of the intervals (i.e. whether E′ is less than E). If so, then in step 1414, the rescaled partition is stored and the associated entropy E′ is substituted for the previously calculated value E. If not, the in step 1416, the scaling is reduced (for example, by reducing the value of the predetermined constant).

In either case, with either the new partition or the decreased scaling constant, in step 1418, provided that the loop counter j has not reached a predetermined threshold J, the loop counter is incremented in step 1420 and the calculating device 126 returns to step 1408. Once J iterations have been performed (step 1418) the partition thus calculated is returned to the process of FIG. 8.

Thus, the process starts with a uniform partition of the range with intervals of the same length or intervals each containing the same number of data. Then the calculating device 126 determines how much each interval contributes to the overall entropy, i.e., referring to equations Equation 1 and Equation 2, it determines, for each interval, the value:

$$- \frac{{n}_{i}}{n} {\sum }_{q = 1}^{c} \frac{{k}_{q}}{{n}_{i}} \cdot log ( \frac{{k}_{q}}{{n}_{i}} ) = - \frac{1}{n} {\sum }_{q = 1}^{c} {k}_{q} \cdot log ( \frac{{k}_{q}}{{n}_{i}} ) \qquad Equation 3$$

Based on these values, intervals for which Equation 3 is small are enlarged in width and intervals with a high contribution to the entropy (i.e. those for which Equation 3 is large) are reduced in width. This scaling procedure is repeated until no further improvements an be achieved within a fixed number of steps.

### From Interval Partitions to Fuzzy Partitions

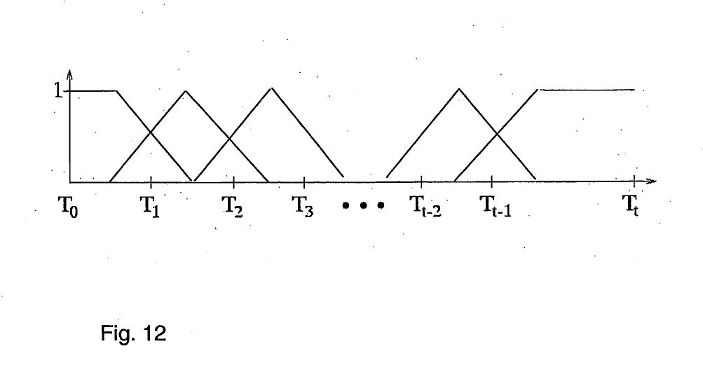

From the partitions computed for each attribute, fuzzy sets are constructed in the following way by the calculating device 126, referring to FIG. 12.

The partition into t intervals is defined by the cut points T₁, . . . , Tₜ₋₁. T₀ and Tₜ denote the left and right boundary of the corresponding attribute range. Except for the left and right boundaries of each range, triangular membership functions are used, taking their maxima in the centre of respective intervals and reaching the membership degree zero at the centres of the neighbouring intervals. At the left and right boundaries of the ranges trapezoidal membership functions are used, which are one between the boundary of the range and the centre of the first, respectively, last interval and reach the membership degree zero at the centre of the neighbouring interval.

Taking Correlations into Account (Partition Simplification)

The construction of the fuzzy sets (i.e. the discretisation) was based on the reduction of entropy/information gain, when each variable is considered independently. However, when attributes are correlated, it might be possible to further reduce the number of intervals (i.e. fuzzy sets). In order to evaluate the information gain of partitions for combinations of variables, we have to consider the partition of the product space into hyper-boxes induced by the interval partitions of the single domains.

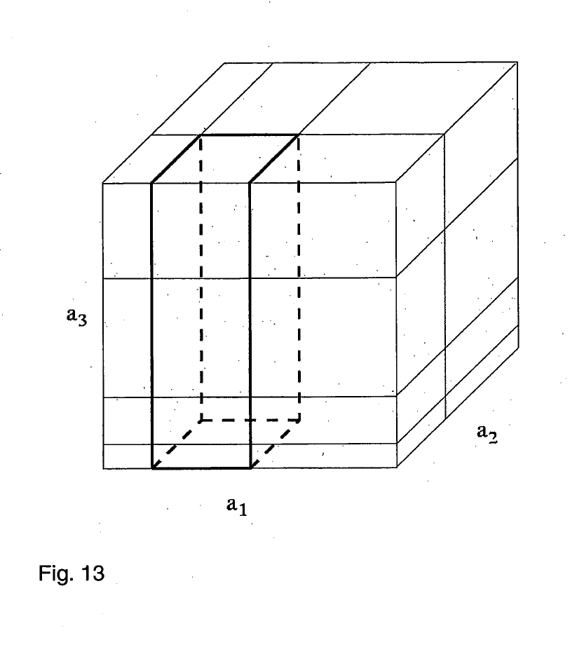

In principle, one would have to apply Equation 1 and Equation 2 to hyper-boxes instead of intervals and find the optimal partition into hyper-boxes. In this case, we do not ignore data with missing values, but assign them to larger hyper-boxes corresponding to unions of hyper-boxes. In FIG. 13, such a larger box is shown, which is induced by choosing the second (of three) intervals of attribute a₁, the first (of two) intervals of attribute a₂ and a missing value in attribute a₃.

Unfortunately, however, the technique of choosing cut points as boundary points does not make sense in multi-dimensional spaces. The above-described heuristic method of minimising the overall entropy by scaling the intervals with respect to their entropy could in principle be applied to the multi-dimensional case as well, but only at the price of an exponential increase of computational costs in terms of the number of attributes.

If we have tⱼ intervals for attribute j (j=1, . . . , p), we would have to compute the entropy for

$${\prod }_{j = 1}^{p} ( {t}_{j} + 1 )$$

hyper-boxes for the overall entropy value of one partition into hyper-boxes, including the hyper-boxes representing regions with missing values. In case of six attributes, each one split into three intervals, we would have to consider (3+1)₆=4096 hyper-boxes for the evaluation of one partition.

Therefore, according to the preferred embodiment, the calculating device 126 does not try to find an overall optimal partition into hyper-boxes, but instead simplifies the partitions already obtained from the single domain partitions. The partitions are generated in an incremental way as described above. Advantageously, not only the final resulting partitions are stored, but also those partitions with fewer intervals which were derived during the process of finding the final resulting partitions. This enables the calculating device 126 to check, for a given attribute, whether it can return to a partition with fewer intervals without increasing the entropy significantly, when this attribute is reviewed in connection with other attributes.

There are two alternative embodiments utilising respective different strategies, applied depending on the number of data and the number of hyper-boxes that are induced by the single domain partitions. The first strategy (FIG. 10) is chosen, if the data set is not too large and the number of hyper-boxes is sufficiently small.

Referring to FIG. 10, in this embodiment, first of all (step 1452), the attributes are sorted with respect to the reduction of entropy that their associated interval partitions provide, by the calculating device 126. For the comparison, required for the sorting, missing attribute values in the training data should be taken into account.

Let E denote the overall entropy of the data set with n data. Assume that for mⱼ data attribute j has a missing value. Then the corresponding entropy in terms of Equation 2 would be

$$E = {\sum }_{i = 1}^{t} \frac{{n}_{i}}{n - {m}_{j}} \cdot {E}_{i}$$

(simply ignoring the data with missing values).

In the extreme case that all data except for one have a missing value for attribute j, this entropy would reduce to zero, although the actual information gain by knowing attribute j is almost zero. Therefore, we define:

$$E = \frac{n - {m}_{j}}{n} \cdot {\sum }_{i = 1}^{t} \frac{{n}_{i}}{n - {m}_{j}} \cdot {E}_{i} + \frac{{m}_{j}}{n} \cdot {E}_{missing} = \frac{1}{n} \cdot {\sum }_{i = 1}^{t} {n}_{i} \cdot {E}_{i} + \frac{{m}_{j}}{n} \cdot {E}_{missing} \qquad Equation 4$$

E_{missing} is the entropy of the data with a missing value for the j^{th} attribute. Assuming that missing values occur randomly, E_{missing} will coincide with the overall entropy of the data set.

In step 1454, an attribute loop counter i is initialised at 0 and in step 1456 it is incremented. Attributes are therefore processed in order such that the process starts with the attribute whose partition leads to the highest reduction of the entropy and proceeds to examine the attribute which was next best in the entropy reduction. In step 1458, the calculating device 126 determines whether all attributes have been processed (i.e. whether i is not less than the number of attributes) and if so, in step 1460, the current partitions are returned for subsequent use in forming fuzzy sets as explained above.

If not all attributes have been processed, in step 1462, the total entropy E of all attributes up to and including the current one is calculated. In step 1464, the calculating device 126 determines whether the number of intervals for the current attribute can be reduced. Consider the hyper-boxes that are induced by the partition of the ranges of these two attributes. Considering single attributes in isolation, t intervals were chosen for the attribute that was second best in the entropy reduction. The entropies for the partition previously computed for t−1 (and stored) during the process of FIG. 7 are retrieved (step 1466). The (hyper-box) entropies in connection with the best attribute using the partition are compared with the retrieved ones (step 1468). The resulting entropy E′ for attributes 1 to i is again calculated (as in step 1462). If the partition with t−1 intervals does not significantly increase the entropy (i.e. does so by less than a threshold p, step 1470), it is selected to replace the current one (step 1466) and the process is repeated from step 1464, until no further simplification is possible. Thus, the process examines the partitions with t−2, t−3 etc intervals, until the increase in entropy seems unacceptable.

After that, the process returns to step 1452 to select the next attribute (sorted, as disclosed above, in the single domain entropy reduction) and so on until all attributes have been processed (step 1458).

Since this strategy means that we might have to consider a very large number of hyper-boxes for the last attributes to be investigated, a second strategy (FIG. 11) is applied when the first one (FIG. 10) seems computationally unacceptable. It follows the same principle as in the first strategy, but applies the method pair-wise, to all pairs of attributes, to try to reduce the number of intervals of the attribute with the lesser reduction of entropy in each pair.

Steps 1552 to 1570 essentially correspond to steps 1452-1470 described above, except that the attributes are sorted into pairs, and each pair is selected in turn, and the next pair selected until all are processed, rather than proceeding attribute by attribute.

Also, in calculating the entropies in steps 1562 and 1568, it is the entropies for the pair of attributes which is calculated, rather than that for all attributes up to and including the current one as in FIG. 10. Thus, the calculations performed within each iteration are the same complexity, rather than growing more complex on each successive attribute as in FIG. 10, thus making the process more scalable.

FIG. 6 shows how to combine the previously introduced algorithms to obtain an overall strategy to compute suitable partitions for all attributes taking their correlations or dependencies into account.

### Other Embodiments and Modifications

It will be apparent that many variations and modifications to the above described embodiments can be made. For example, the above described embodiments can be applied to any form of pattern recognition task, and therefore not limited to the realm of detecting fraudulent documents or transactions. Each of the above described embodiments could be used independently of the others, rather than in combination as described.

Rather than triangular sets, the membership functions could be calculated in some other shape which can be described by a centre and edge parameters, such as a Gaussian curve.

The evaluation of the rules in terms of a max-min inference scheme could also be replaced by any other suitable combination of a t-conorm (max or sum or OR-type) operation and a t-norm (product or AND-type) operation.

Accordingly, the present invention extends to any and all such modifications and variations. For the avoidance of doubt, protection is hereby sought for all novel subject matter or combinations therefore disclosed herein.

1. Apparatus for generating classifier parameters from a plurality of multivariate sample data, for use in subsequent classification, said classifier parameters relating to a plurality of intervals on each of the variables, said intervals being associated with classes, comprising:
means for inputting said sample data;
means for storing said sample data;
means for calculating a plurality of boundaries for each of said variables from said sample data; and
means for deriving parameters defining said intervals from said boundaries.

2. Apparatus according to claim 1, in which said calculating means comprises;
means for selecting a first number of said intervals, having positions based on said boundaries, and means for selecting an increased number of said intervals, for determining whether said increased number would classify better than said first number and, if so, for substituting said increased number for said first number, and if not, for retaining said number of intervals.

3. Apparatus according to claim 1, in which said calculating means comprises means for evaluating all sets of intervals which can be constructed from said boundaries and retaining a preferred one of said sets.

4. Apparatus according to claim 1, in which said calculating means comprises means for determining the number of said boundaries and, if said number falls below a predetermined threshold, evaluating all sets of intervals which can be constructed from said boundaries and retaining a preferred one of said sets, and, if said number falls above said threshold, for selecting an increased number of said intervals, for determining whether said increased number would classify better than said first number and, if so, for substituting said increased number for said first number, and if not, for retaining said number of intervals.

5. Apparatus according to claim 1, comprising means for determining data defining the boundaries of a predetermined number of said intervals.

6. Apparatus according to claim 5, in which said determining means comprises means for enlarging first said intervals and shrinking second said intervals so as to improve classification of said sample data.

7. Apparatus according to claim 1, comprising means for recalculating the number of said boundaries on each said variable based on those of other said variables.

8. Apparatus according to claim 7, in which said recalculating means comprises means for testing the effect of reducing the number of intervals on each said variable.

9. Apparatus according to claim 8, comprising means for storing each said first number for each said variable.

10. Apparatus according to claim 1, wherein one or more of said intervals are fuzzy sets.

11. Apparatus according to claim 1, comprising means for inputting a plurality of test data and for classifying said test data as belonging to one of a plurality of classes.

12. Apparatus according to claim 11, in which one or more of said classes correspond to data classified as being indicative of one or more fraudulent items or actions.

13. Apparatus according to claim 12, comprising a plurality of sensors from which said variables are generated.

14. A method of generating classifier parameters from a plurality of multivariate sample data, for use in subsequent classification, said classifier parameters relating to a plurality of intervals on each of the variables, said intervals being associated with classes, said method comprising:
inputting said sample data;
calculating a plurality of boundaries for each of said variables from said sample data; and
deriving parameters defining said intervals from said boundaries.

15. A method according to claim 14, further comprising classifying test data using said parameters.

16. A method according to claim 15, further comprising regenerating said parameters using further sample data.

17. A method according to claim 16, in which said further sample data is derived from previous test data.
